(19) United States
(12) Patent Application Publication
(10) Pub. No.: US 2015/0256229 A1
(43) Pub. Date: Sep. 10, 2015

(54) SYSTEMS AND METHODS FOR IMPROVING THE ROBUSTNESS OF AN NFC FORUM PEER-TO-PEER LINK

(71) Applicant: QUALCOMM Incorporated, San Diego, CA (US)

(72) Inventors: John Hillan, Farnborough (GB); Dubai Chingalande, Farnborough (GB)

(21) Appl. No.: 14/592,620

(22) Filed: Jan. 8, 2015

Related U.S. Application Data
(60) Provisional application No. 61/949,967, filed on Mar. 7, 2014.

(51) Int. Cl. H04B 5/00

(52) U.S. Cl. CPC H04B 5/0075

(57) ABSTRACT

A method is described. The method includes sending data, by an initiator inductively coupled communication device, to a target inductively coupled communication device. The method also includes starting a link timeout (LTO) timer. The method further includes determining that a media access control (MAC) layer on the initiator inductively coupled communication device indicates that error recovery is being attempted. The method additionally includes extending a time interval of the LTO timer.

### RELATED APPLICATIONS

This application is related to and claims priority from U.S. Provisional Patent Application Ser. No. 61/949,967, filed Mar. 7, 2014, for “Improving the Robustness of an NFC Forum Peer-To-Peer Link.”

### TECHNICAL FIELD

The present disclosure relates generally to wireless communications. More specifically, the present disclosure relates to improving the robustness of an NFC Forum peer-to-peer link.

### BACKGROUND

Advances in technology have resulted in smaller and more powerful personal computing devices. For example, there currently exist a variety of portable personal computing devices, including wireless computing devices, such as portable wireless telephones, personal digital assistants (PDAs) and paging devices that are each small, lightweight, and can be easily carried by users. More specifically, the portable wireless telephones, for example, further include cellular telephones that communicate voice and data packets over wireless networks. Many such cellular telephones are being manufactured with relatively large increases in computing capabilities, and as such, are becoming tantamount to small personal computers and hand-held PDAs. Further, such devices are being manufactured to enable communications using a variety of frequencies and applicable coverage areas, such as cellular communications, wireless local area network (WLAN) communications, near field communication (NFC), etc.

When NFC is implemented, an NFC enabled device may initially detect an NFC tag and/or target device. Thereafter, communications between NFC devices may use an NFC data exchange protocol (DEP). The present NFC Forum specifications allow for communications to occur between devices using a number of stack partitions (known as RF Interfaces). Benefits may be realized by improving the robustness of an NFC Forum peer-to-peer link.

### SUMMARY

A method is described. The method includes sending data, by an initiator inductively coupled communication device, to a target inductively coupled communication device. The method also includes starting a link timeout (LTO) timer. The method further includes determining that a media access control (MAC) layer on the initiator inductively coupled communication device indicates that error recovery is being attempted. The method additionally includes extending a time interval of the LTO timer.

The initiator inductively coupled communication device may be an initiator near-field communication (NFC) device and the target inductively coupled communication device may be a target NFC device. The initiator NFC device may be in a peer-to-peer connection with the target NFC device.

The method may also include providing an error recovery indication from the MAC layer to a logical link control protocol (LLCP) layer on the initiator NFC device. The MAC layer may be a near-field communication data exchange protocol (NFC-DEP) layer. The error recovery indication may be passed from the NFC-DEP layer on the initiator NFC device to the LLCP layer on the initiator NFC device. The error recovery indication may be passed over an NFC controller interface (NCI).

The time interval of the LTO timer may be reset to a start value. The time interval of the LTO timer may be stalled for an amount of time relevant to a given error recovery attempt.

It may be determined that error recovery is being attempted when at least one of a negative acknowledgment message protocol data unit (NACK-PDU) or an attention request protocol data unit (ATN-PDU) has been sent to the target inductively coupled communication device.

An initiator inductively coupled communication device is also described. The initiator inductively coupled communication device includes a processor, memory in electronic communication with the processor, and instructions stored in the memory. The instructions are executable by the processor to send data to a target inductively coupled communication device. The instructions are also executable to start an LTO timer. The instructions are further executable to determine that a MAC layer on the initiator inductively coupled communication device indicates that error recovery is being attempted. The instructions are additionally executable to extend a time interval of the LTO timer.

A method is also described. The method includes sending data, by a target inductively coupled communication device, to an initiator inductively coupled communication device. The method also includes starting an LTO timer. The method further includes determining that a MAC layer on the target inductively coupled communication device indicates that error recovery is being attempted by the target inductively coupled communication device. The method additionally includes extending a time interval of the LTO timer.

The target inductively coupled communication device may be a target NFC device and the initiator inductively coupled communication device is an initiator NFC device. The target NFC device may be in a peer-to-peer connection with the initiator NFC device.

The method may also include providing an error recovery indication from the MAC layer to a LLCP layer on the target NFC device. The MAC layer is a NFC-DEP layer. An error recovery indication may be passed from the NFC-DEP layer on the target NFC device to the LLCP layer on the target NFC device. The error recovery indication may be passed over an NCI.

The time interval of the LTO timer may be reset to a start value. The time interval of the LTO timer may be stalled for an amount of time relevant to a given error recovery attempt.

It may be determined that error recovery is being attempted when a NACK-PDU has been received from the initiator inductively coupled communication device. It may be determined that error recovery is being attempted when an ATN-PDU has been received from the initiator inductively coupled communication device. It may be determined that error recovery is being attempted when a transmission error is detected in an RF frame from the initiator inductively coupled communication device.

A target inductively coupled communication device is also described. The target inductively coupled communication device includes a processor, memory in electronic communication with the processor, and instructions stored in the memory. The instructions are executable by the processor to send data to an initiator inductively coupled communication device. The instructions are also executable to start an LTO timer. The instructions are further executable to determine that a MAC layer on the target inductively coupled communication device indicates that error recovery is being attempted. The instructions are additionally executable to extend a time interval of the LTO timer.

### BRIEF DESCRIPTION OF THE DRAWINGS

FIG. 1 is a block diagram illustrating one configuration of a wireless communication system;

FIG. 2 is a flow diagram illustrating a method for adjusting an link timeout (LTO) timer when error recovery activity is detected by an initiator near field communication (NFC) device;

FIG. 3 is a flow diagram illustrating a method for adjusting an LTO timer when error recovery activity is detected by a target NFC device;

FIG. 4 is a block diagram illustrating one configuration of inductive communication in a wireless communication system;

FIG. 5 shows a simplified schematic diagram of a near-field wireless communication system;

FIG. 6 is a flow diagram illustrating a more detailed configuration of a method for adjusting an LTO timer when error recovery activity is detected by an initiator NFC device;

FIG. 7 is a flow diagram illustrating a more detailed configuration of a method for adjusting an LTO timer when error recovery activity is detected by a target NFC device;

FIGS. 8A and 8B are a call flow diagram illustrating the use of adjusting an LTO timer when error recovery activity is detected;

FIGS. 9A and 9B are another call flow diagram illustrating the use of adjusting an LTO timer when error recovery activity is detected;

FIGS. 10A and 10B are yet another call flow diagram illustrating the use of adjusting an LTO timer when error recovery activity is detected; and

FIG. 11 illustrates certain components that may be included within an electronic device.

### DETAILED DESCRIPTION

It should be noted that some communication devices may communicate wirelessly and/or may communicate using a wired connection or link. For example, some communication devices may communicate with other devices using an Ethernet protocol. The systems and methods disclosed herein may be applied to communication devices that communicate wirelessly and/or that communicate using a wired connection or link. In one configuration, the systems and methods disclosed herein may be applied to a communication device that communicates with another device using near-field communication (NFC).

Various configurations are now described with reference to the Figures, where like reference numbers may indicate functionally similar elements. The systems and methods as generally described and illustrated in the Figures herein could be arranged and designed in a wide variety of different configurations. Thus, the following more detailed description of several configurations, as represented in the Figures, is not intended to limit scope, as claimed, but is merely representative of the systems and methods described herein.

As described herein, a device may recognize an NFC target device and/or tag when within range of the coverage area of the NFC device and/or tag. The term NFC tag refers to an integrated circuit that provides NFC functionality. After an NFC target device and/or tag have been located, the device may obtain sufficient information to allow for communications to be established. One form of communication that may be established is a peer device that implements NFC Forum logical link control protocol (LLCP). Communications between the devices may be enabled over a variety of NFC radio frequency (RF) technologies, such as, but not limited to, NFC-A, NFC-B, NFC-F, etc.

Generally, a device host (DH) may be operable in an environment that is not substantially limited by memory constraints while also potentially operating with comparatively higher power consumption. By contrast, an NFC controller (NFCC) may be operable in a memory limited environment while consuming comparatively less power.

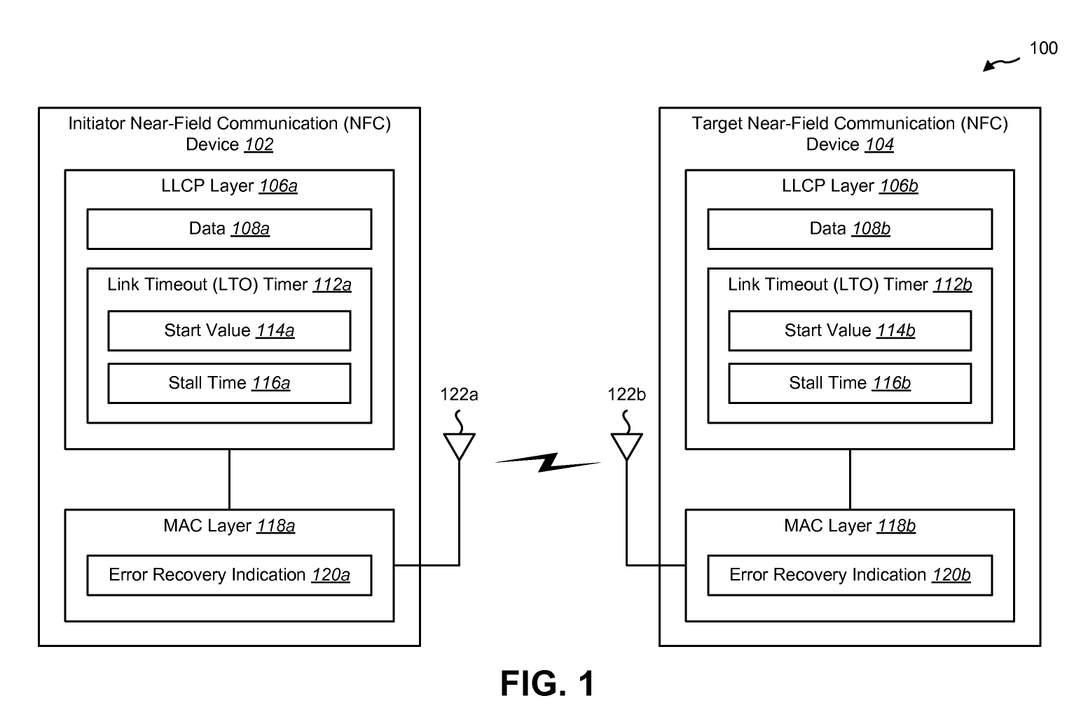

FIG. 1 is a block diagram illustrating one configuration of a wireless communication system 100. The wireless communication system 100 may include one or more initiator near-field communication (NFC) devices 102 and one or more target NFC devices 104. The initiator NFC device 102 may be in communication with a target NFC device 104.

NFC is an inductively coupled communication. Therefore, the initiator NFC device 102 and the target NFC device 104 may also be referred to as inductively coupled communication devices. The antenna 122 of one NFC device produces a radiated field (e.g., a magnetic field) that is received by the other NFC device. In one configuration, the initiator NFC device 102 and the target NFC device 104 may use one or more NFC technologies (e.g., NFC-A, NFC-B and NFC-F) to communicate with each other.

In one configuration, the initiator NFC device 102 and the target NFC device 104 may be operable to communicate using NFC through various interfaces, such as a frame RF interface, ISO-data exchange protocol (DEP) RF interface and NFC-DEP RF interface. In another configuration, the initiator NFC device 102 and the target NFC device 104 may establish an NFC-DEP RF protocol based communication link with link layer connections defined through a logical link control protocol (LLCP). In still another configuration, the initiator NFC device 102 and the target NFC device 104 may be operable to be connected to an access network and/or core network (e.g., a CDMA network, a GPRS network, a UMTS network, and other types of wireline and wireless communication networks).

In some scenarios, an NFC Forum device may implement an LLCP peer-to-peer communication protocol. The LLCP layer 106 is a logical link layer providing mechanisms that allow client applications to operate with the appearance of a symmetric link to an application on a peer device (i.e., the initiator NFC device 102 or target NFC device 104). A media access control (MAC) layer 118 defined for use with the LLCP layer 106 is the NFC-DEP.

In one configuration, the LLCP layer 106 and the MAC layer 118 are included in an NFC controller (NFCC). In another configuration, the LLCP layer 106 is included in the device host (DH) of an NFC device and the MAC layer 118a is included in the NFCC of the NFC device. The DH may generally perform operations on the NFC device. One example of the DH includes a processor and memory, where the processor runs an operating system. Examples of operating systems that may be run by the DH include Android, iOS, Windows Phone, Windows RT and Blackberry.

The LLCP layer 106 may place some constraints on the configuration of the NFC-DEP to work correctly. For example, one constraint is to attempt to allow time for NFC-DEP level error recovery to be attempted should transmission or timeout errors arise. Allowing time for NFC-DEP level error recovery may increase the robustness of the link at the LLCP level.

The NFC-DEP may recover from transmission errors. However, there are timeout error scenarios where the LLCP link will time out before the error recovery can be completed. Thus, the LLCP link may time out even if NFC-DEP level error recovery would have been successful.

To improve the robustness of the peer-to-peer link, the initiator NFC device 102 and the target NFC device 104 may include mechanisms in which the MAC layer 118 (i.e., the NFC-DEP layer) informs the LLCP layer 106 about error recovery activity. The LLCP layer 106 may extend the time interval of a link timeout (LTO) timer 112 based on the error recovery indication 120.

In one configuration, the initiator NFC device 102 may send data 108a to a target NFC device 104 over a peer-to-peer connection. The initiator NFC device 102 may establish the peer-to-peer connection with the target NFC device 104 using a logical link control (LLC) link. The LLCP layer 106a of the initiator NFC device 102 may provide the data 108a to the MAC layer 118a of the initiator NFC device 102.

Upon providing the data 108a to the MAC layer 118a of the initiator NFC device 102, the LLCP layer 106a may start an LTO timer 112a. The LTO timer 112a may be set to a start value 114a, which may be fixed or may be configurable depending on the context of the communication. When the LTO timer 112a expires, the initiator NFC device 102 may execute one or more link deactivation procedures. For example, the initiator NFC device 102 may perform an LLC link deactivation procedure or a MAC link deactivation procedure.

The MAC layer 118b of the target NFC device 104 may receive the data 108a via an antenna 122b. However, in some cases, there may be an error in the communication between the MAC layer 118a of the initiator NFC device 102 and the MAC layer 118b of the target NFC device 104. For example, the MAC layer 118a of the initiator NFC device 102 may not receive an anticipated response from the MAC layer 118b of the target NFC device 104. This may be due to interference when transmitting a signal between the initiator NFC device 102 and the target NFC device 104 that results in a frame transmission error.

Upon determining that there is a frame transmission error, the MAC layer 118a may attempt an error recovery. For example, the MAC layer 118a may send a negative acknowledgment (NACK) message (e.g., a NACK-protocol data unit (PDU)) to the target NFC device 104 or may receive a NACK message from the target NFC device 104. In another example, the MAC layer 118a may send an attention request (e.g., ATN-PDU) to the target NFC device 104 or the MAC layer 118a may receive an attention request from the target NFC device 104. In yet another example, error recovery may be attempted when the MAC layer 118a detects a transmission error in an RF frame from the target NFC device 104.

When attempting error recovery, the MAC layer 118a may provide an error recovery indication 120a to the LLCP layer 106a of the initiator NFC device 102. The error recovery indication 120a may indicate to the LLCP layer 106a that error recovery is being attempted by the MAC layer 118a. In the configuration where the LLCP layer 106a is included in the device host (DH) and the MAC layer 118a is included in the NFCC of the initiator NFC device 102, the error recovery indication 120a may be passed from the MAC layer 118a over an NFC controller interface (NCI).

Upon receiving the error recovery indication 120a, the LLCP layer 106a may determine that the MAC layer 118a is attempting an error recovery. The LLCP layer 106a may extend the time interval of the LTO timer 112a. In one configuration, the LTO timer 112a may be reset to a start value 114a. In another configuration, the LTO timer 112a may be stalled for an amount of time (i.e., a stall time 116a) relevant to a given error recovery attempt. In other words, the LTO timer 112a may be paused for different amounts of time depending on the type of error recovery attempt being performed.

The target NFC device 104 may have similar mechanisms for informing the LLCP layer 106b of an error recovery attempt. In one scenario, the LLCP layer 106b may provide data 108b to the MAC layer 118b to send to the initiator NFC device 102. The LLCP layer 106b of the target NFC device 104 may start an LTO timer 112b upon sending the data 108b to the MAC layer 118b. If the MAC layer 118b encounters a transmission error, the MAC layer 118b may attempt error recovery with the initiator NFC device 102. It should be noted that the LTO timer 112b of the target NFC device 104 may have a different value than the LTO timer 112a of the initiator NFC device 102. In one example, the start values 114 of the LTO timers 112a-b of the initiator NFC device 102 and the target NFC device 104 may be configured upon establishing the peer-to-peer link. These start values 114 for the LTO timers 112a-b may or may not be the same.

In another scenario, the MAC layer 118b of the target NFC device 104 may expect to receive data 108a from the initiator NFC device 102. If the data 108a does not arrive within a time period, the MAC layer 118b may determine that a frame transmission error has occurred and the initiator NFC device 102 may be attempting to perform error recovery.

The MAC layer 118b may provide an error recovery indication 120b to the LLCP layer 106b of the target NFC device 104. As with the initiator NFC device 102, the LLCP layer 106b and the MAC layer 118b of the target NFC device 104 may be included in an NFCC. In another configuration, the LLCP layer 106b may be included in the DH and the MAC layer 118b may be included in the NFCC of the target NFC device 104. In this configuration, the error recovery indication 120b may be passed from the MAC layer 118b over an NCI to the LLCP layer 106b.

The LLCP layer 106b of the target NFC device 104 may extend the time interval of the LTO timer 112b upon receiving the error recovery indication 120b. In one configuration, the LTO timer 112b may be reset to a start value 114b. In another configuration, the LTO timer 112b may be stalled for an amount of time (e.g., stall time 116b) relevant to a given error recovery attempt.

By providing an error recovery indication 120 to the LLCP layer 106, the LLCP layer 106 may have the ability to modify the LTO timer 112 prior to link timeout. This may prevent the LLCP link from timing out when the NFC-DEP level error recovery would have been successful. This may improve the robustness of an NFC Forum peer-to-peer link, which may improve user experience. With the systems and methods described herein, sporadic timeout errors at the NFC-DEP level are less likely to result in the user-visible end result of the entire link timing out and all transactions being interrupted.

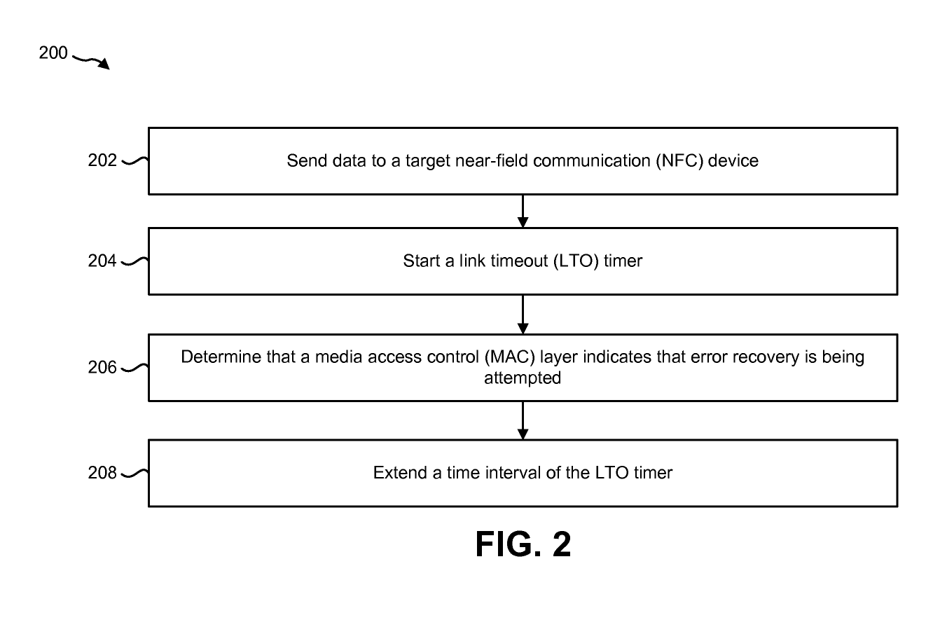

FIG. 2 is a flow diagram illustrating a method 200 for adjusting an LTO timer 112 when error recovery activity is detected by an initiator NFC device 102. The method 200 may be performed by the initiator NFC device 102 as part of a peer-to-peer link with a target NFC device 104. For example, the initiator NFC device 102 may establish an LLC link with the target NFC device 104.

The initiator NFC device 102 may send 202 data 108a to the target NFC device 104. Examples of data 108 include contact information, setup information for more complex wireless communication protocols (such as Bluetooth and Wi-Fi), credit card information and identity and access tokens, a JPG image, Word document, etc. The data 108a may be included in one or more transmit (TX) PDUs.

Upon sending the data 108a to the target NFC device 104, the initiator NFC device 102 may start 204 an LTO timer 112a. If the LTO timer 112a expires, the initiator NFC device 102 may execute an LLC link deactivation procedure.

The initiator NFC device 102 may determine 206 that the MAC layer 118a indicates that error recovery is being attempted. In one configuration, the initiator NFC device 102 may determine whether the NFC-DEP layer on the initiator NFC device 102 has provided an error recovery indication 120a to the LLCP layer 106a on the initiator NFC device 102.

The NFC-DEP layer may provide an error recovery indication 120a to the LLCP layer when error recovery has been detected during the peer-to-peer connection with the target NFC device 104. For example, error recovery may occur when the initiator NFC device 102 sends a NACK-PDU to the target NFC device 104. In another example, the initiator NFC device 102 may send an ATN-PDU to the target NFC device 104 or receive an ATN-PDU from the target NFC device 104. Error recovery may also occur when the initiator NFC device 102 detects a transmission error in an RF frame from the target NFC device 104.

The initiator NFC device 102 may extend 208 a time interval of the LTO timer 112a. In one configuration, the LTO timer 112a may be reset to a start value 114a. In another configuration, the LTO timer 112a may be stalled for an amount of time relevant to a given error recovery attempt. After extending the time interval of the LTO timer 112a, the initiator NFC device 102 may return to determining whether the MAC layer 118a has indicated that error recovery is being attempted.

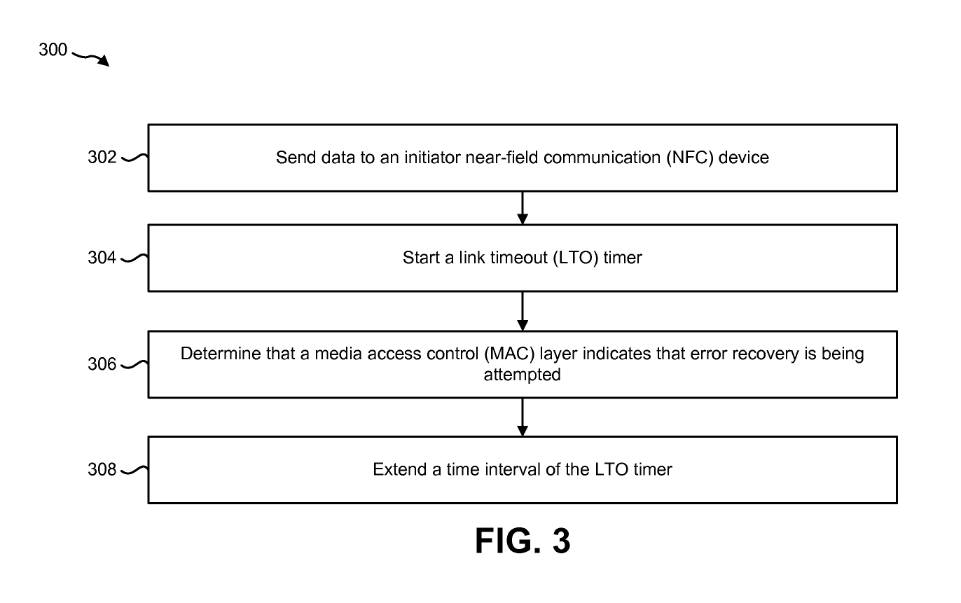

FIG. 3 is a flow diagram illustrating a method 300 for adjusting an LTO timer 112 when error recovery activity is detected by a target NFC device 104. The method 300 may be performed by the target NFC device 104 as part of a peer-to-peer link with an initiator NFC device 102. For example, the target NFC device 104 may establish an LLC link with the initiator NFC device 102.

The target NFC device 104 may send 302 data 108b to the initiator NFC device 102. The data 108b may be included in one or more PDUs (e.g., a TX PDU).

Upon sending the data 108b to the initiator NFC device 102, the target NFC device 104 may start 304 an LTO timer 112b. If the LTO timer 112b expires, the target NFC device 104 may execute a MAC link deactivation procedure. This may be done to disconnect the link with the initiator NFC device 102.

The target NFC device 104 may determine 306 that the MAC layer 118b indicates that error recovery is being attempted. In one configuration, the target NFC device 104 may determine whether the NFC-DEP layer on the target NFC device 104 has provided an error recovery indication 120b to the LLCP layer 106b on the target NFC device 104.

The NFC-DEP layer may provide an error recovery indication 120b to the LLCP layer 106b when error recovery has been detected during the peer-to-peer connection with the initiator NFC device 102. This may be accomplished as described above in connection with FIG. 2.

The target NFC device 104 may extend 308 a time interval of the LTO timer 112b. In one configuration, the LTO timer 112b may be reset to a start value 114b. In another configuration, the LTO timer 112b may be stalled for an amount of time relevant to a given error recovery attempt. After extending the time interval of the LTO timer 112b, the target NFC device 104 may return to determining whether the MAC layer 118b has indicated that error recovery is being attempted.

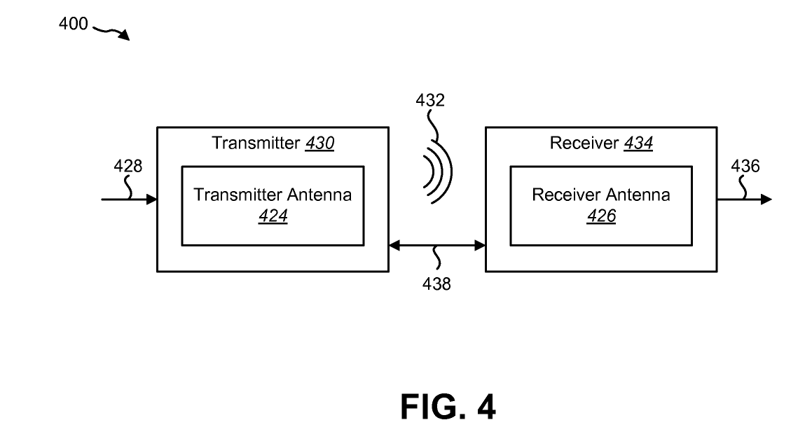

FIG. 4 is a block diagram illustrating one configuration of inductively coupled communication in a wireless communication system 400. In one configuration, the inductively coupled communication may be near-field communication (NFC).

Input power 428 is provided to a transmitter 430 for generating a radiated field 432 for providing energy transfer. A receiver 434 couples to the radiated field 432 and generates an output power 436 for storing or consumption by a device (not shown) coupled to the output power 436. Both the transmitter 430 and the receiver 434 are separated by a distance 438. In one exemplary configuration, the transmitter 430 and receiver 434 are configured according to a mutual resonant relationship, such that when the resonant frequency of the receiver 434 and the resonant frequency of transmitter 430 are very close, transmission losses between the transmitter 430 and the receiver 434 are minimal when the receiver 434 is located in the “near-field” of the radiated field 432.

The transmitter 430 further includes a transmit antenna 424 for providing a means for energy transmission and the receiver 434 further includes a receive antenna 426 for providing a means for energy reception. An efficient energy transfer may occur by coupling a large portion of the energy in the near field of the transmitting antenna 424 to a receiving antenna 426 rather than propagating most of the energy in an electromagnetic wave to the far field. When in this near-field, a coupling mode may be developed between the transmit antenna 424 and the receive antenna 426. The area around the transmit antenna 424 and the receive antenna 426 where this near-field coupling may occur is referred to as a coupling-mode region.

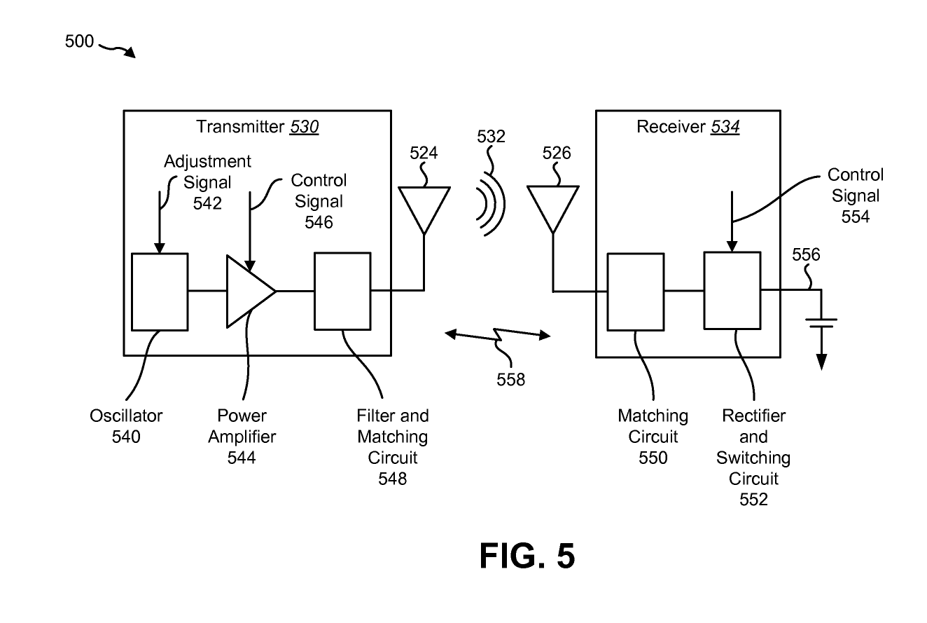

FIG. 5 shows a simplified schematic diagram of a near-field wireless communication system 500. The transmitter 530 includes an oscillator 540, a power amplifier 544 and a filter and matching circuit 548. The oscillator 540 is configured to generate a signal at a desired frequency, which may be adjusted in response to an adjustment signal 542. The oscillator 540 signal may be amplified by the power amplifier 544 with an amplification amount responsive to a control signal 546. The filter and matching circuit 548 may be included to filter out harmonics or other unwanted frequencies and match the impedance of the transmitter 530 to the transmit antenna 524. The transmit antenna 524 may transmit a radiated field 532.

The receiver 534 may include a matching circuit 550 and a rectifier and switching circuit 552 to generate a DC power output 556 to charge a battery or power a device coupled to the receiver (not shown). The matching circuit 550 may be included to match the impedance of the receiver 534 to the receive antenna 526. The rectifier switching circuit 552 may be adjusted by a control signal 554. The receiver 534 and transmitter 530 may communicate on a separate communication channel 558 (e.g., Bluetooth, zigbee, cellular, etc.).

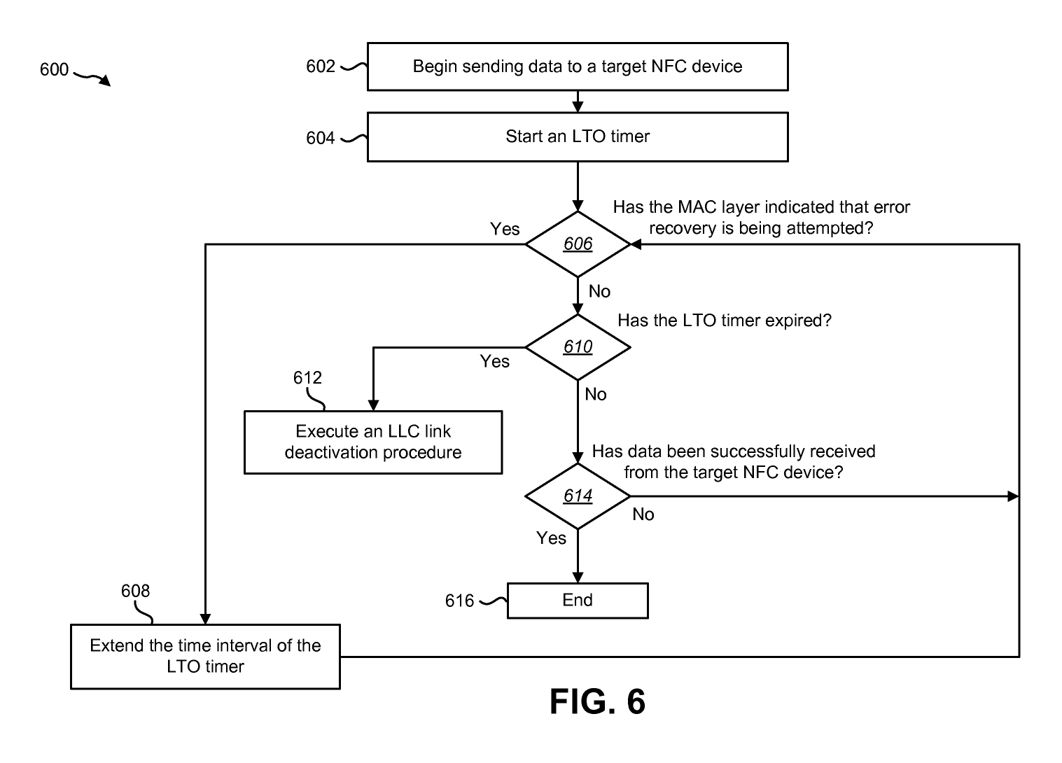

FIG. 6 is a flow diagram illustrating a more detailed configuration of a method 600 for adjusting an LTO timer 112 when error recovery activity is detected by an initiator NFC device 102. The method 600 may be performed by an initiator NFC device 102 as part of a peer-to-peer link. Thus, the initiator NFC device 102 may be involved in a peer-to-peer link with a target NFC device 104.

The initiator NFC device 102 may begin 602 sending data to a target NFC device 104. The data 108a may be included in one or more transmit (TX) PDUs. Once the initiator NFC device 102 has finished sending data 108a to the target NFC device 104, the initiator NFC device 102 may start 604 an LTO timer 112a.

The initiator NFC device 102 may determine 606 whether the MAC layer 118a has indicated that error recovery is being attempted. In other words, the initiator NFC device 102 may determine whether the NFC-DEP layer on the initiator NFC device 102 has provided an error recovery indication 120a to the LLCP layer 106a on the initiator NFC device 102.

The NFC-DEP layer may provide an error recovery indication 120a to the LLCP layer 106a when error recovery has been detected during the peer-to-peer connection with the target NFC device 104. For example, error recovery may occur when a NACK-PDU has been sent to the target NFC device 104 or when an ATN-PDU has been sent to the target NFC device 104. If an attempt at error recovery is detected, it is possible that a PDU from the remote LLC is being received. Therefore, an error recovery indication 120a may be provided to the local LLC layer (e.g., the LLCP layer 106a) to inform the LLC layer of the error recovery attempt.

If the MAC layer 118a provides an error recovery indication 120a to the LLCP layer 106a, the LLCP layer 106a may extend 608 the time interval of the LTO timer 112a. In one configuration, the LLCP layer 106a may simply restart (e.g., reload) the LTO timer 112a with the start value 114a. In another configuration, the LLCP layer 106a may make more sophisticated calculations to freeze the countdown of the LTO timer 112a for the amount of time needed for a given error recovery attempt. In other words, the LLCP layer 106a may be stalled for an amount of time (i.e., a stall time 116a) relevant to a given error recovery attempt. After extending the time interval of the LTO timer 112a, the initiator NFC device 102 may return to determining 606 whether the MAC layer 118a has indicated that error recovery is being attempted.

If the initiator NFC device 102 determines 606 that the MAC layer 118a has not indicated that error recovery is being attempted, the initiator NFC device 102 may determine 610 whether the LTO timer 112a has expired. If the LTO timer 112a has expired, the initiator NFC device 102 may execute 612 an LLC link deactivation procedure.

If the LTO timer 112a has not expired, the initiator NFC device 102 may determine 614 whether data 108b has been successfully received from the target NFC device 104. If data 108b has been successfully received from the target NFC device 104, the method 600 may end 616. If data 108b has not been successfully received from the target NFC device 104, the initiator NFC device 102 may return to determining 606 whether the MAC layer 118a has indicated that error recovery is being attempted.

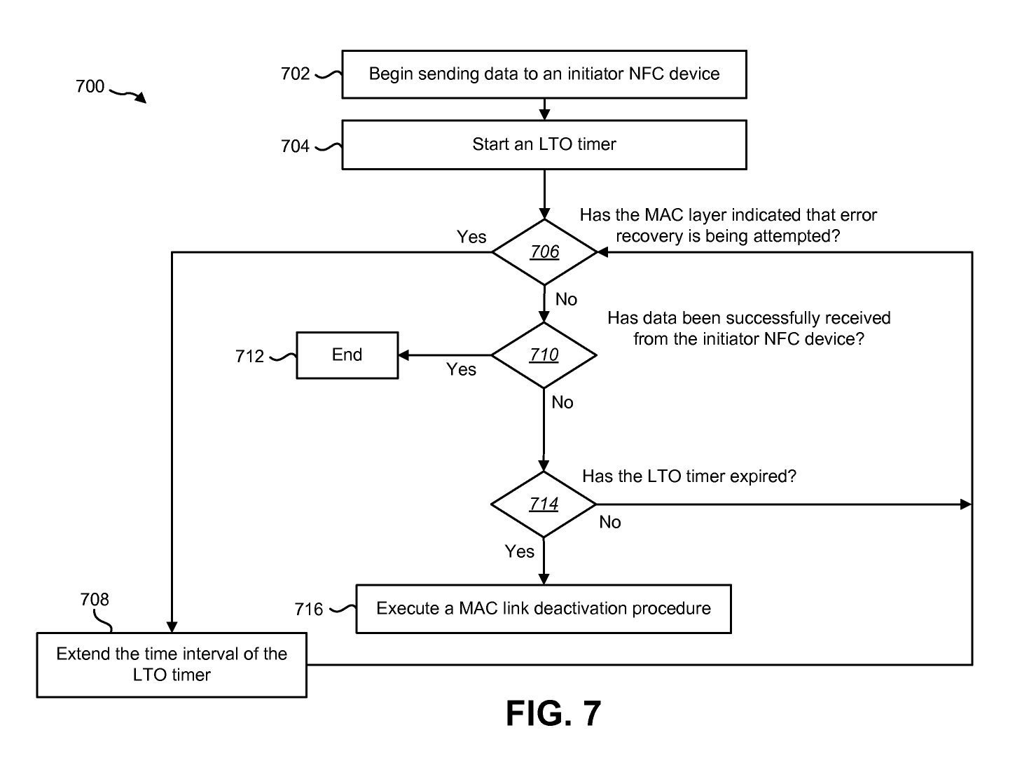

FIG. 7 is a flow diagram illustrating a more detailed configuration of a method 700 for adjusting an LTO timer 112 when error recovery activity is detected by a target NFC device 104. The method 700 may be performed by a target NFC device 104 as part of a peer-to-peer link. Thus, the target NFC device 104 may be involved in a peer-to-peer link with an initiator NFC device 102.

The target NFC device 104 may begin sending data 108b to an initiator NFC device 102. The data 108b may be included in one or more TX PDUs.

Once the target NFC device 104 has finished sending data 108b to the initiator NFC device 102, the target NFC device 104 may start 704 an LTO timer 112b. The LTO timer 112b on the target NFC device 104 may have the same or different values than the LTO timer 112a on the initiator NFC device 102. For example, the LTO timer 112b on the target NFC device 104 may be for 500 milliseconds (ms) while the LTO timer 112a on the initiator NFC device 102 may be for 250 ms.

The target NFC device 104 may determine 706 whether the MAC layer 118b has indicated that error recovery is being attempted. In other words, the target NFC device 104 may determine whether the NFC-DEP layer on the target NFC device 104 has provided an error recovery indication 120b to the LLCP layer 106b on the target NFC device 104. For example, error recovery may occur when a NACK-PDU has been received from the initiator NFC device 102, when an ATN-PDU has been received from the initiator NFC device 102 or when a transmission error is detected in an RF frame from the initiator NFC device 102.

If the MAC layer 118b provides an error recovery indication 120b to the LLCP layer 106b, the LLCP layer 106b may extend 708 the time interval of the LTO timer 112b. In one configuration, the LLCP layer 106b may simply restart the LTO timer 112b with the start value 114b. In another configuration, the LLCP layer 106b may be stalled for an amount of time (i.e., a stall time 116b) relevant to a given error recovery attempt. After extending the time interval of the LTO timer 112b, the target NFC device 104 may return to determining 706 whether the MAC layer 118b has indicated that error recovery is being attempted.

If the target NFC device 104 determines 706 that the MAC layer 118b has not indicated that error recovery is being attempted, the target NFC device 104 may determine 710 whether data 108a has been successfully received from the initiator NFC device 102. If the data 108a has been received successfully, the method 700 may end 712.

If the data 108a has not been received successfully, the target NFC device 104 may determine 714 whether the LTO timer 112b has expired. If the LTO timer 112b has expired, the target NFC device 104 may execute 716 a MAC link deactivation procedure. In other words, if nothing can be done to protect the link from deactivating unnecessarily, the link deactivation may proceed as described in the present specifications.

If the LTO timer 112b has not expired, the target NFC device 104 may return to determining 706 whether the MAC layer 118b has indicated that error recovery is being attempted.

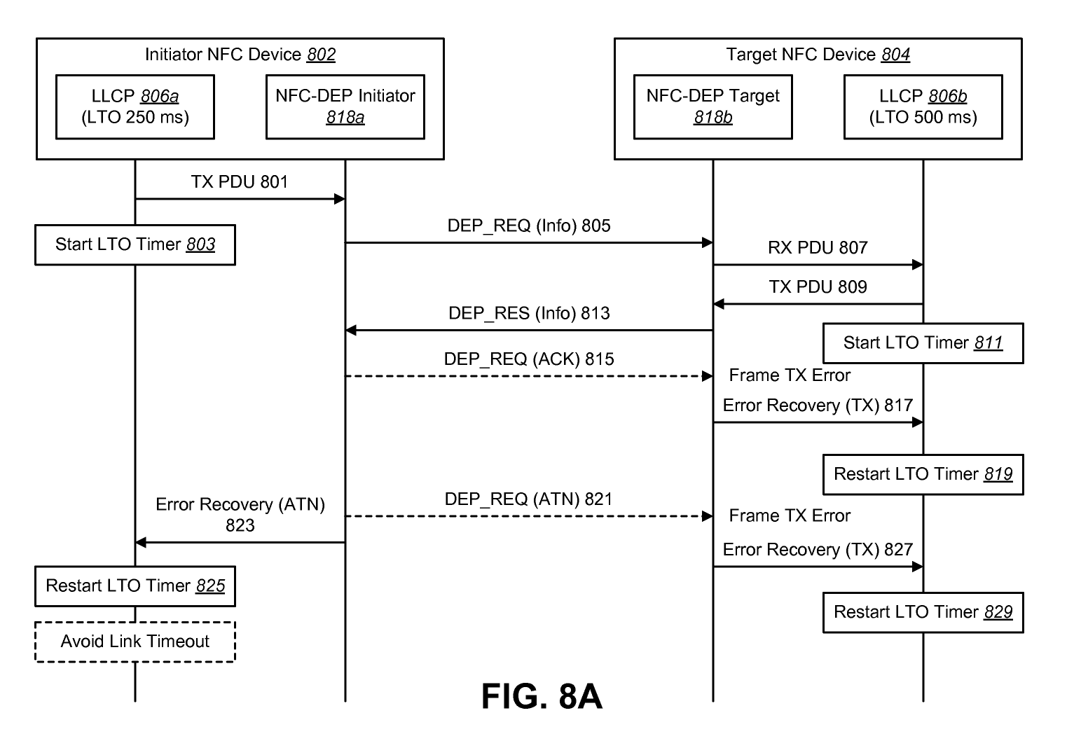

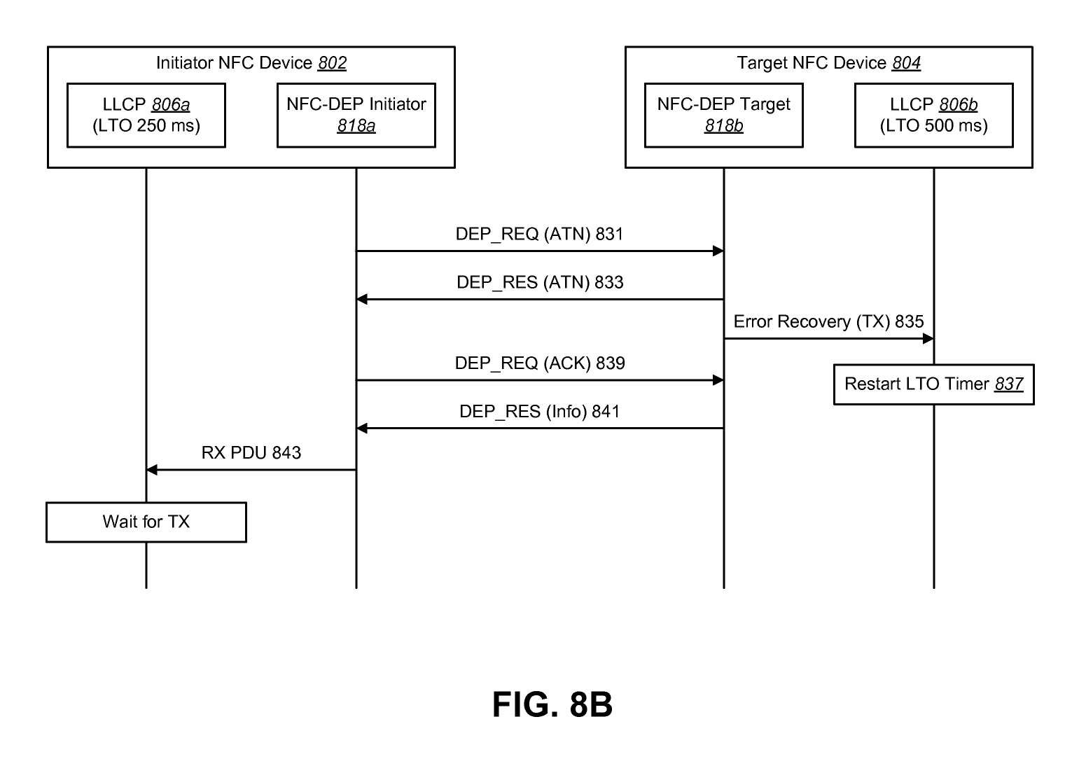

FIGS. 8A and 8B are a call flow diagram illustrating the use of adjusting an LTO timer 112 when error recovery activity is detected. Layers within an initiator NFC device 802 and a target NFC device 804 are illustrated. The initiator NFC device 802 includes an LLCP layer 806a and an NFC-DEP initiator layer 818a. The target NFC device 804 includes an LLCP layer 806b and an NFC-DEP target layer 818b.

As illustrated in FIG. 8A, the initiator NFC device 802 may begin transmitting data 108a to the target NFC device 804. In the example illustrated in FIGS. 8A and 8B, the LLCP layer 806a on the initiator NFC device 802 may use a 250 ms LTO timer 112a and the LLCP layer 806b on the target NFC device 804 may use a 500 ms LTO timer 112b.

The LLCP layer 806a on the initiator NFC device 802 may provide 801 a TX PDU to the NFC-DEP initiator layer 818a. The LLCP layer 806a on the initiator NFC device 802 may then start 803 an LTO timer 112a (also referred to as wait for reception (RX)). The NFC-DEP initiator layer 818a may transmit 805 a DEP_REQ (info) to the NFC-DEP target layer 818b. The DEP_REQ (info) may include the data 108a payload.

Upon receiving the DEP_REQ (info), the NFC-DEP target layer 818b may then provide 807 an RX PDU to the LLCP layer 806b on the target NFC device 804. The LLCP layer 806b on the target NFC device 804 may provide 809 a TX PDU to the NFC-DEP target layer 818b. The LLCP layer 806b on the target NFC device 804 may then start 811 an LTO timer 112b.

The NFC-DEP target layer 818b may send 813 a DEP_RES (info) to the NFC-DEP initiator layer 818a. The NFC-DEP initiator layer 818a may respond by sending 815 an acknowledgment (ACK) message (DEP_REQ (ACK)) back to the NFC-DEP target layer 818b. However, in the example illustrated, a frame TX error occurs while the DEP_REQ (ACK) is being transmitted. In this configuration, the error is detected by the NFC-DEP target layer 818b due to a timeout of the expected ACK message. Thus, the NFC-DEP target layer 818b sends 817 an error recovery indication 120b to the LLCP layer 806b on the target NFC device 804. In response, the LLCP layer 806b on the target NFC device 804 restarts 819 the LTO timer 112b.

After a waiting period without a response from the target NFC device 804, the NFC-DEP initiator layer 818a may send 821 an attention request (e.g., DEP_REQ (ATN)) to the NFC-DEP target layer 818b. The NFC-DEP initiator layer 818a may also send 823 an error recovery indication 120a to the LLCP layer 806a on the initiator NFC device 802. Thus, the LLCP layer 806a on the initiator NFC device 802 may restart 825 the LTO timer 112a, thereby avoiding a deactivation procedure.

In this example, another frame TX error occurs while the DEP_REQ (ATN) is being transmitted. The error is once again detected by the NFC-DEP target layer 818b due to a timeout of the expected response from the initiator NFC device 802. The NFC-DEP target layer 818b may provide 827 another error recovery indication 120b to the LLCP layer 806b on the target NFC device 804. The LLCP layer 806b on the target NFC device 804 may restart 829 the LTO timer 112b in response to receiving the error recovery indication 120b.

Continuing on FIG. 8B, after another waiting period, the NFC-DEP initiator layer 818a may send 831 another attention request (DEP_REQ (ATN)) to the NFC-DEP target layer 818b. In this case, the NFC-DEP target layer 818b properly receives the DEP_REQ (ATN) without a frame TX error. After receiving the DEP_REQ (ATN) from the NFC-DEP initiator layer 818a without a frame TX error, the NFC-DEP target layer 818b may send 833 an attention response DEP_RES (ATN) back to the NFC-DEP initiator layer 818a. The NFC-DEP target layer 818b may also send 835 another error recovery indication 120b to the LLCP layer 806b on the target NFC device 804. In response to the error recovery indication 120b, the LLCP layer 806b on the target NFC device 804 may again restart 837 the LTO timer 112b.

After receiving the DEP_RES (ATN) from the NFC-DEP target layer 818b, the NFC-DEP initiator layer 818a may resend 839 the earlier DEP_REQ (ACK) to the NFC-DEP target layer 818b. The NFC-DEP target layer 818b may then send 841 a DEP_RES (info) back to the NFC-DEP initiator layer 818a. The NFC-DEP initiator layer 818a may then provide 843 the RX PDU to the LLCP layer 806a on the initiator NFC device 802.

In the absence of the error recovery indications 120a from the NFC-DEP initiator layer 818a, the LLCP layer 806a on the initiator NFC device 802 may have timed out despite error recovery being successful. Therefore, by providing the error recovery indications 120a from the NFC-DEP initiator layer 818a, the LLCP layer 806a may avoid link timeout.

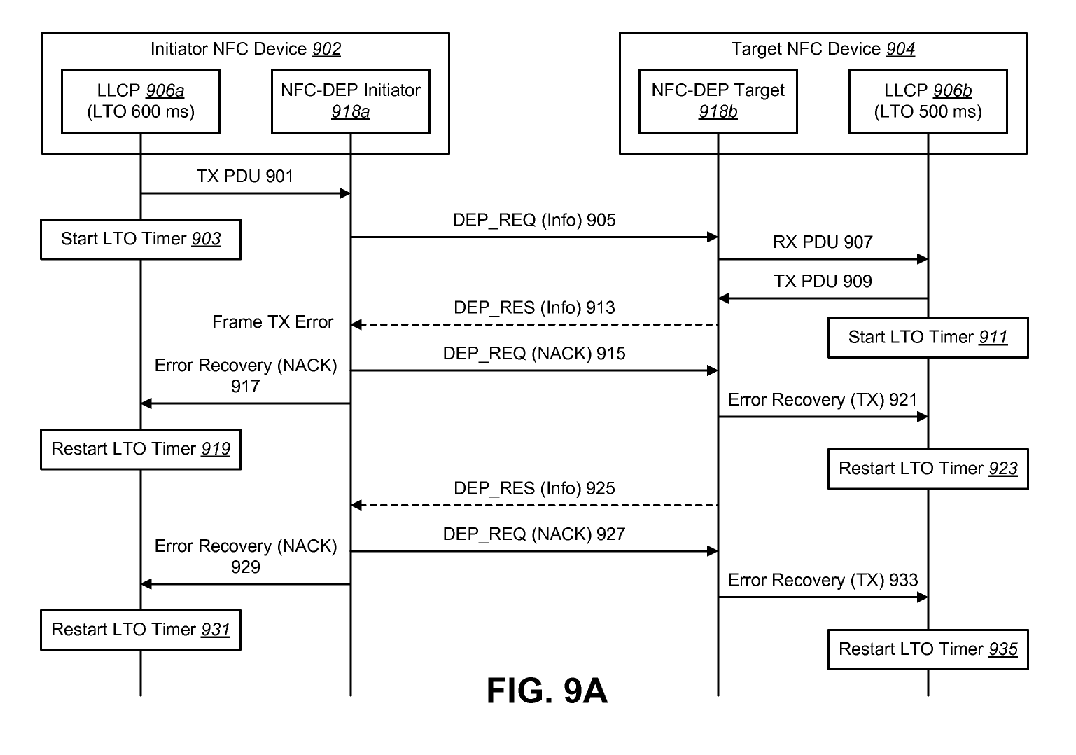

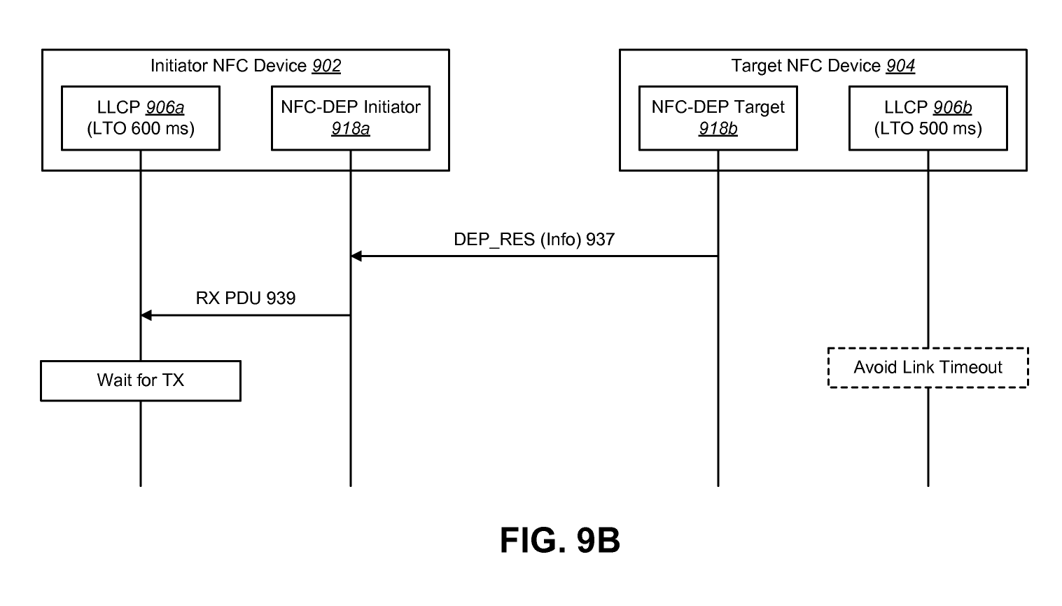

FIGS. 9A and 9B are another call flow diagram illustrating the use of adjusting an LTO timer 112 when error recovery activity is detected. Layers within an initiator NFC device 902 and a target NFC device 904 are illustrated. The initiator NFC device 902 includes an LLCP layer 906a and an NFC-DEP initiator layer 918a. The target NFC device 904 includes an LLCP layer 906b and an NFC-DEP target layer 918b.

As illustrated in FIG. 9A, the initiator NFC device 902 may begin transmitting data to the target NFC device 904. In the example illustrated in FIGS. 9A and 9B, the LLCP layer 906a on the initiator NFC device 902 may initially use a 600 ms LTO timer 112a and the LLCP layer 906b on the target NFC device 904 may initially use a 500 ms LTO timer 112b.

The LLCP layer 906a on the initiator NFC device 902 may provide 901 a TX PDU to the NFC-DEP initiator layer 918a. The LLCP layer 906a on the initiator NFC device 902 may then start 903 an LTO timer 112a (also referred to as wait for RX). The NFC-DEP initiator layer 918a may transmit 905 a DEP_REQ (info) to the NFC-DEP target layer 918b.

Upon receiving the DEP_REQ (info), the NFC-DEP target layer 918b may provide 907 an RX PDU to the LLCP layer 906b on the target NFC device 904. The LLCP layer 906b on the target NFC device 904 may provide 909 a TX PDU to the NFC-DEP target layer 918b. The LLCP layer 906b on the target NFC device 904 may then start 911 an LTO timer 112b.

The NFC-DEP target layer 918b may send 913 a DEP_RES (info) to the NFC-DEP initiator layer 918a. However, a frame TX error may occur with the DEP_RES (info). The NFC-DEP initiator layer 918a may detect the frame TX error and respond by sending 915 a retransmit request DEP_REQ (NACK) back to the NFC-DEP target layer 918b.

The NFC-DEP initiator layer 918a may also provide 917 an error recovery indication 120a to the LLCP layer 906a on the initiator NFC device 902. In response to the error recovery indication 120a, the LLCP layer 906a on the initiator NFC device 902 may restart 919 the LTO timer 112a. Furthermore, in response to receiving the DEP_REQ (NACK), the NFC-DEP target layer 918b may provide 921 an error recovery indication 120b to the LLCP layer 906b on the target NFC device 904. The LLCP layer 906b on the target NFC device 904 may restart 923 the LTO timer 112b.

The NFC-DEP target layer 918b may again send 925 a DEP_RES (info) to the NFC-DEP initiator layer 918a. However, a frame TX error may again occur with the DEP_RES (info). The NFC-DEP initiator layer 918a may detect the frame TX error and respond by sending 927 a retransmit request DEP_REQ (NACK) back to the NFC-DEP target layer 918b.

The NFC-DEP initiator layer 918a may also provide 929 an error recovery indication 120a to the LLCP layer 906a on the initiator NFC device 902. In response to the error recovery indication 120a, the LLCP layer 906a on the initiator NFC device 902 may restart 931 the LTO timer 112a. In response to receiving the DEP_REQ (NACK), the NFC-DEP target layer 918b may provide 933 an error recovery indication 120b to the LLCP layer 906b on the target NFC device 904. The LLCP layer 906b on the target NFC device 904 may restart 935 the LTO timer 112b.

Continuing on FIG. 9B, the NFC-DEP target layer 918b may once again send 937 a DEP_RES (info) to the NFC-DEP initiator layer 918a. Upon receiving the DEP_RES (info), the NFC-DEP initiator layer 918a may provide 939 an RX PDU to the LLCP layer 906a on the initiator NFC device 902.

In the absence of the indications of error recovery from the NFC-DEP target layer 918b, the LLCP layer 906b on the target NFC device 904 may have timed out. Therefore, by providing the error recovery indications 120b from the NFC-DEP target layer 918b, the LLCP layer 906b may avoid link timeout.

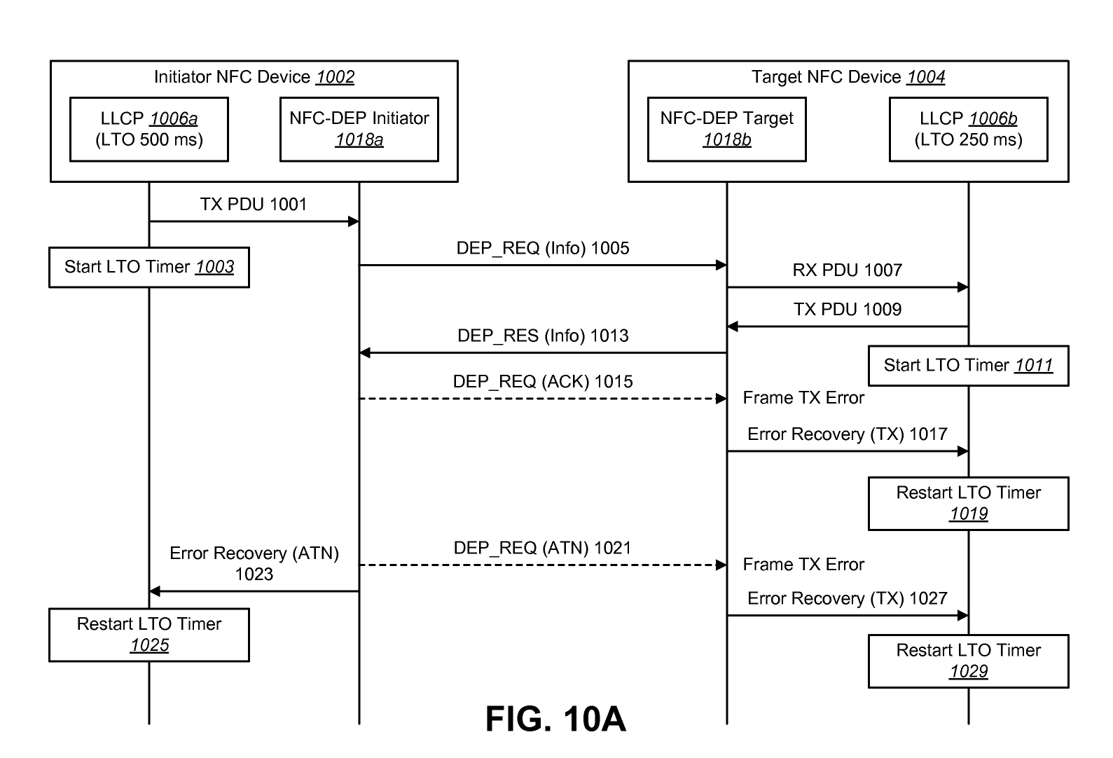

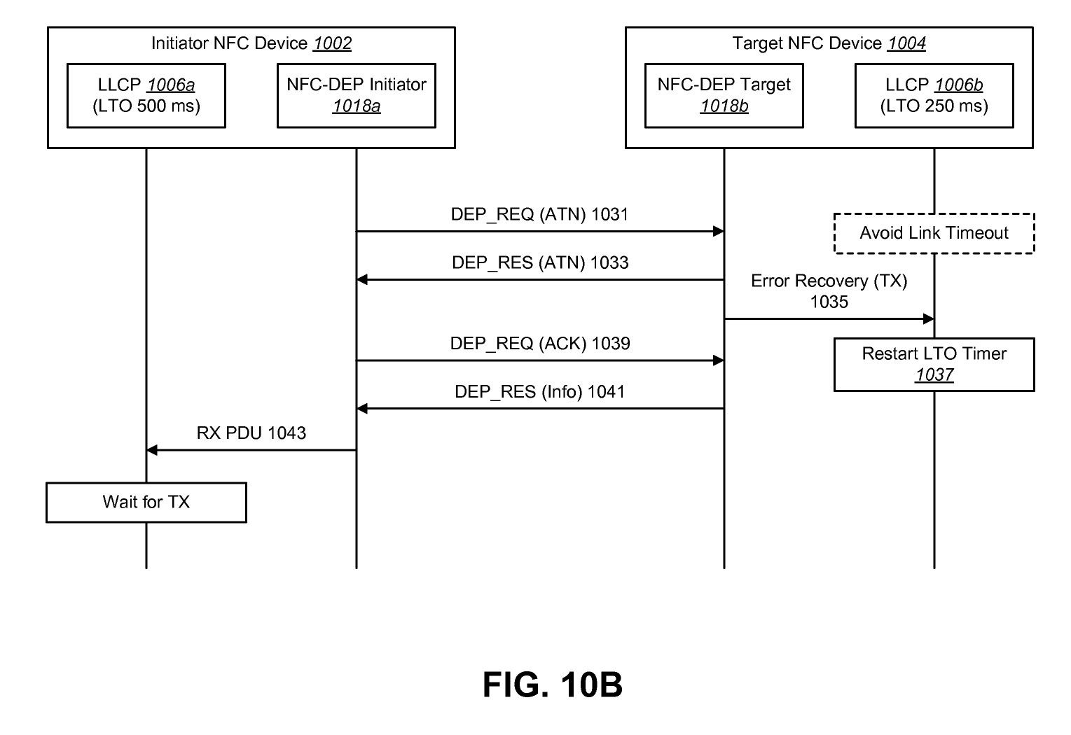

FIGS. 10A and 10B are yet another call flow diagram illustrating the use of adjusting an LTO timer 112 when error recovery activity is detected. Layers within an initiator NFC device 1002 and a target NFC device 1004 are illustrated. The initiator NFC device 1002 includes an LLCP layer 1006a and an NFC-DEP initiator layer 1018a. The target NFC device 1004 includes an LLCP layer 1006b and an NFC-DEP target layer 1018b.

As illustrated in FIG. 10A, the initiator NFC device 1002 may begin transmitting data 108a to the target NFC device 1004. In the example illustrated in FIGS. 10A and 10B, the LLCP layer 1006a on the initiator NFC device 1002 may use a 500 ms LTO timer 112a and the LLCP layer 1006b on the target NFC device 1004 may use a 250 ms LTO timer 112b. The LTO values used on each NFC device 1002, 1004 may indicate which LLCP layer 1006 will timeout first if error recovery indicators 120 are not used.

The LLCP layer 1006a on the initiator NFC device 1002 may provide 1001 a TX PDU to the NFC-DEP initiator layer 1018a. The LLCP layer 1006a on the initiator NFC device 1002 may then start 1003 an LTO timer 112a (also referred to as wait for RX). The NFC-DEP initiator layer 1018a may transmit 1005 a DEP_REQ (info) to the NFC-DEP target layer 1018b. The NFC-DEP target layer 1018b may then provide 1007 an RX PDU to the LLCP layer 1006b on the target NFC device 1004. The LLCP layer 1006b on the target NFC device 1004 may provide 1009 a TX PDU to the NFC-DEP target layer 1018b. The LLCP layer 1006b on the target NFC device 1004 may then start 1011 an LTO timer 112b.

The NFC-DEP target layer 1018b may send 1013 a DEP_RES (info) to the NFC-DEP initiator layer 1018a. The NFC-DEP initiator layer 1018a may respond by sending 1015 a DEP_REQ (ACK) back to the NFC-DEP target layer 1018b. However, in the example illustrated, a frame TX error occurs while the DEP_REQ (ACK) is being transmitted. In this configuration, the error is detected by the NFC-DEP target layer 1018b. Thus, the NFC-DEP target layer 1018b sends 1017 an error recovery indication 120b to the LLCP layer 1006b on the target NFC device 1004. In response, the LLCP layer 1006b on the target NFC device 1004 restarts 1019 the LTO timer 112b.

After a waiting period without a response from the target NFC device 1004, the NFC-DEP initiator layer 1018a may send 1021 an attention request DEP_REQ (ATN) to the NFC-DEP target layer 1018b. The NFC-DEP initiator layer 1018a may also send 1023 an error recovery indication 120a to the LLCP layer 1006a on the initiator NFC device 1002. Thus, the LLCP layer 1006a on the initiator NFC device 1002 may restart 1025 the LTO timer 112a, thereby avoiding a deactivation procedure.

In this example, another frame TX error occurs while the DEP_REQ (ATN) is being transmitted. The error is once again detected by the NFC-DEP target layer 1018b due to a timeout of the expected response from the initiator NFC device 1002. The NFC-DEP target layer 1018b may provide 1027 another error recovery indication 120b to the LLCP layer 1006b on the target NFC device 1004. The LLCP layer 1006b on the target NFC device 1004 may restart 1029 the LTO timer 112b in response to receiving the error recovery indication 120b.

Continuing on FIG. 10B, after another waiting period, the NFC-DEP initiator layer 1018a may send 1031 another attention request (DEP_REQ (ATN)) to the NFC-DEP target layer 1018b. In this case, the NFC-DEP target layer 1018b properly receives the DEP_REQ (ATN) without a frame TX error. After receiving the DEP_REQ (ATN) from the NFC-DEP initiator layer 1018a without a frame TX error, the NFC-DEP target layer 1018b may send 1033 an attention response DEP_RES (ATN) back to the NFC-DEP initiator layer 1018a. The NFC-DEP target layer 1018b may also send 1035 another error recovery indication 120b to the LLCP layer 1006b on the target NFC device 1004. In response to the error recovery indication 120b, the LLCP layer 1006b on the target NFC device 1004 may again restart 1037 the LTO timer 112b.

After receiving the DEP_RES (ATN) from the NFC-DEP target layer 1018b, the NFC-DEP initiator layer 1018a may resend 1039 the earlier DEP_REQ (ACK) to the NFC-DEP target layer 1018b. The NFC-DEP target layer 1018b may then send 1041 a DEP_RES (info) back to the NFC-DEP initiator layer 1018a. The NFC-DEP initiator layer 1018a may then provide 1043 the RX PDU to the LLCP layer 1006a on the initiator NFC device 1002.

In the absence of the indications of error recovery from the NFC-DEP target layer 1018b, the LLCP layer 1006b on the target NFC device 1004 may have timed out. Therefore, by providing the error recovery indications 120b from the NFC-DEP target layer 1018b, the LLCP layer 1006b may avoid link timeout.

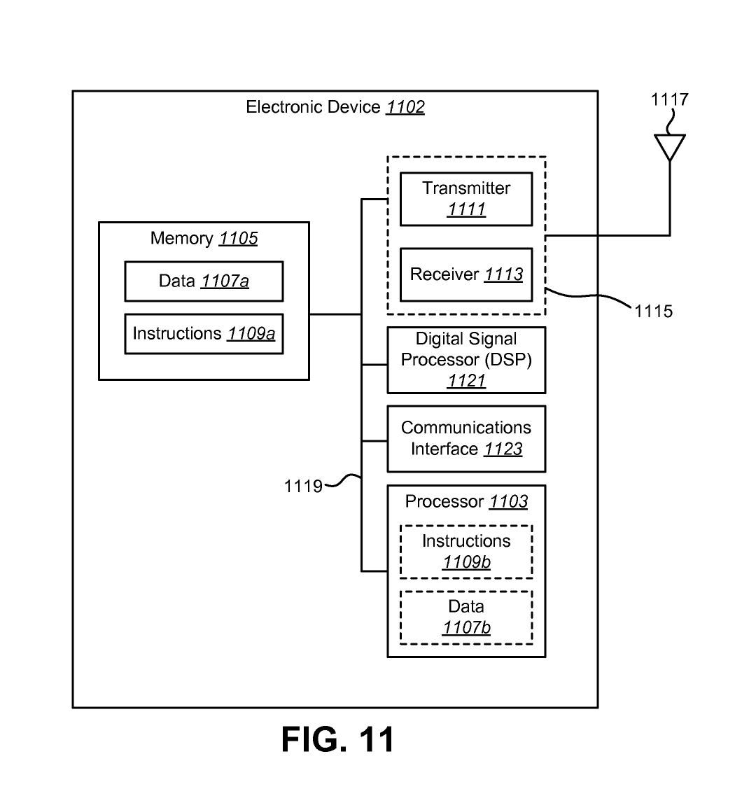

FIG. 11 illustrates certain components that may be included within an electronic device 1102. The electronic device 1102 may be an access terminal, a mobile station, a user equipment (UE), etc. For example, the electronic device 1102 may be the initiator NFC device 102 or the target NFC device 104 of FIG. 1.

The electronic device 1102 includes a processor 1103. The processor 1103 may be a general purpose single- or multi-chip microprocessor (e.g., an Advanced RISC (Reduced Instruction Set Computer) Machine (ARM)), a special purpose microprocessor (e.g., a digital signal processor (DSP)), a microcontroller, a programmable gate array, etc. The processor 1103 may be referred to as a central processing unit (CPU). Although just a single processor 1103 is shown in the electronic device 1102 of FIG. 11, in an alternative configuration, a combination of processors (e.g., an ARM and DSP) could be used.

The electronic device 1102 also includes memory 1105 in electronic communication with the processor (i.e., the processor can read information from and/or write information to the memory). The memory 1105 may be any electronic component capable of storing electronic information. The memory 1105 may be configured as random access memory (RAM), read-only memory (ROM), magnetic disk storage media, optical storage media, flash memory devices in RAM, on-board memory included with the processor, EPROM memory, EEPROM memory, registers and so forth, including combinations thereof.

Data 1107a and instructions 1109a may be stored in the memory 1105. The instructions may include one or more programs, routines, sub-routines, functions, procedures, code, etc. The instructions may include a single computer-readable statement or many computer-readable statements. The instructions 1109a may be executable by the processor 1103 to implement the methods disclosed herein. Executing the instructions 1109a may involve the use of the data 1107a that is stored in the memory 1105. When the processor 1103 executes the instructions 1109, various portions of the instructions 1109b may be loaded onto the processor 1103, and various pieces of data 1107b may be loaded onto the processor 1103.

The electronic device 1102 may also include a transmitter 1111 and a receiver 1113 to allow transmission and reception of signals to and from the electronic device 1102 via an antenna 1117. The transmitter 1111 and receiver 1113 may be collectively referred to as a transceiver 1115. The electronic device 1102 may also include (not shown) multiple transmitters, multiple antennas, multiple receivers and/or multiple transceivers.

The electronic device 1102 may include a digital signal processor (DSP) 1121. The electronic device 1102 may also include a communications interface 1123. The communications interface 1123 may allow a user to interact with the electronic device 1102.

The various components of the electronic device 1102 may be coupled together by one or more buses, which may include a power bus, a control signal bus, a status signal bus, a data bus, etc. For the sake of clarity, the various buses are illustrated in FIG. 11 as a bus system 1119.

In the above description, reference numbers have sometimes been used in connection with various terms. Where a term is used in connection with a reference number, this may be meant to refer to a specific element that is shown in one or more of the Figures. Where a term is used without a reference number, this may be meant to refer generally to the term without limitation to any particular Figure.

The term “determining” encompasses a wide variety of actions and, therefore, “determining” can include calculating, computing, processing, deriving, investigating, looking up (e.g., looking up in a table, a database or another data structure), ascertaining and the like. Also, “determining” can include receiving (e.g., receiving information), accessing (e.g., accessing data in a memory) and the like. Also, “determining” can include resolving, selecting, choosing, establishing and the like.

The phrase “based on” does not mean “based only on,” unless expressly specified otherwise. In other words, the phrase “based on” describes both “based only on” and “based at least on.”

The term “processor” should be interpreted broadly to encompass a general purpose processor, a central processing unit (CPU), a microprocessor, a digital signal processor (DSP), a controller, a microcontroller, a state machine, and so forth. Under some circumstances, a “processor” may refer to an application specific integrated circuit (ASIC), a programmable logic device (PLD), a field programmable gate array (FPGA), etc. The term “processor” may refer to a combination of processing devices, e.g., a combination of a digital signal processor (DSP) and a microprocessor, a plurality of microprocessors, one or more microprocessors in conjunction with a digital signal processor (DSP) core, or any other such configuration.

The term “memory” should be interpreted broadly to encompass any electronic component capable of storing electronic information. The term memory may refer to various types of processor-readable media such as random access memory (RAM), read-only memory (ROM), non-volatile random access memory (NVRAM), programmable read-only memory (PROM), erasable programmable read-only memory (EPROM), electrically erasable PROM (EEPROM), flash memory, magnetic or optical data storage, registers, etc. Memory is said to be in electronic communication with a processor if the processor can read information from and/or write information to the memory. Memory that is integral to a processor is in electronic communication with the processor.

The terms “instructions” and “code” should be interpreted broadly to include any type of computer-readable statement(s). For example, the terms “instructions” and “code” may refer to one or more programs, routines, sub-routines, functions, procedures, etc. “Instructions” and “code” may comprise a single computer-readable statement or many computer-readable statements.

The functions described herein may be implemented in software or firmware being executed by hardware. The functions may be stored as one or more instructions on a computer-readable medium. The terms “computer-readable medium” or “computer-program product” refers to any tangible storage medium that can be accessed by a computer or a processor. By way of example, and not limitation, a computer-readable medium may include RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, includes compact disc (CD), laser disc, optical disc, digital versatile disc (DVD), floppy disk and Blu-ray® disc where disks usually reproduce data magnetically, while discs reproduce data optically with lasers. It should be noted that a computer-readable medium may be tangible and non-transitory. The term “computer-program product” refers to a computing device or processor in combination with code or instructions (e.g., a “program”) that may be executed, processed or computed by the computing device or processor. As used herein, the term “code” may refer to software, instructions, code or data that is/are executable by a computing device or processor.

Software or instructions may also be transmitted over a transmission medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of transmission medium.

The methods disclosed herein comprise one or more steps or actions for achieving the described method. The method steps and/or actions may be interchanged with one another without departing from the scope of the claims. In other words, unless a specific order of steps or actions is required for proper operation of the method that is being described, the order and/or use of specific steps and/or actions may be modified without departing from the scope of the claims.

Further, it should be appreciated that modules and/or other appropriate means for performing the methods and techniques described herein, such as those illustrated by FIG. 2, FIG. 3, FIG. 6 and FIG. 7, can be downloaded and/or otherwise obtained by a device. For example, a device may be coupled to a server to facilitate the transfer of means for performing the methods described herein. Alternatively, various methods described herein can be provided via a storage means (e.g., random access memory (RAM), read only memory (ROM), a physical storage medium such as a compact disc (CD) or floppy disk, etc.), such that a device may obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes and variations may be made in the arrangement, operation and details of the systems, methods, and apparatus described herein without departing from the scope of the claims.

What is claimed is:

1. A method, comprising:
sending data, by an initiator inductively coupled communication device, to a target inductively coupled communication device;
starting a link timeout (LTO) timer;
determining that a media access control (MAC) layer on the initiator inductively coupled communication device indicates that error recovery is being attempted; and
extending a time interval of the LTO timer.

2. The method of claim 1, wherein the initiator inductively coupled communication device is an initiator near-field communication (NFC) device and the target inductively coupled communication device is a target NFC device.

3. The method of claim 2, wherein the initiator NFC device is in a peer-to-peer connection with the target NFC device.

4. The method of claim 2, further comprising providing an error recovery indication from the MAC layer to a logical link control protocol (LLCP) layer on the initiator NFC device, wherein the MAC layer is a near-field communication data exchange protocol (NFC-DEP) layer.

5. The method of claim 4, wherein the error recovery indication is passed from the NFC-DEP layer on the initiator NFC device to the LLCP layer on the initiator NFC device.

6. The method of claim 4, wherein the error recovery indication is passed over an NFC controller interface (NCI).

7. The method of claim 1, wherein the time interval of the LTO timer is reset to a start value.

8. The method of claim 1, wherein the time interval of the LTO timer is stalled for an amount of time relevant to a given error recovery attempt.

9. The method of claim 1, wherein it is determined that error recovery is being attempted when at least one of a negative acknowledgment message protocol data unit (NACK-PDU) or an attention request protocol data unit (ATN-PDU) has been sent to the target inductively coupled communication device.

10. An initiator inductively coupled communication device, comprising:
a processor;
memory in electronic communication with the processor; and
instructions stored in the memory, the instructions being executable by the processor to:
send data to a target inductively coupled communication device;
start a link timeout (LTO) timer;
determine that a media access control (MAC) layer on the initiator inductively coupled communication device indicates that error recovery is being attempted; and
extend a time interval of the LTO timer.

11. The initiator inductively coupled communication device of claim 10, wherein the initiator inductively coupled communication device is an initiator near-field communication (NFC) device and the target inductively coupled communication device is a target NFC device.

12. The initiator inductively coupled communication device of claim 11, further comprising instructions executable to provide an error recovery indication from the MAC layer to an LLCP layer on the initiator inductively coupled communication device, wherein the MAC layer is an NFC-DEP layer.

13. The initiator inductively coupled communication device of claim 12, wherein the error recovery indication is passed over an NFC controller interface (NCI).

14. The initiator inductively coupled communication device of claim 10, wherein it is determined that error recovery is being attempted when at least one of a negative acknowledgment message protocol data unit (NACK-PDU) or an attention request protocol data unit (ATN-PDU) has been sent to the target inductively coupled communication device.

15. A method, comprising:
sending data, by a target inductively coupled communication device, to an initiator inductively coupled communication device;
starting a link timeout (LTO) timer;
determining that a media access control (MAC) layer on the target inductively coupled communication device indicates that error recovery is being attempted by the target inductively coupled communication device; and
extending a time interval of the LTO timer.

16. The method of claim 15, wherein the target inductively coupled communication device is a target near-field communication (NFC) device and the initiator inductively coupled communication device is an initiator NFC device.

17. The method of claim 16, wherein the target NFC device is in a peer-to-peer connection with the initiator NFC device.

18. The method of claim 16, further comprising providing an error recovery indication from the MAC layer to a logical link control protocol (LLCP) layer on the target NFC device, wherein the MAC layer is a near-field communication data exchange protocol (NFC-DEP) layer.

19. The method of claim 18, wherein an error recovery indication is passed from the NFC-DEP layer on the target NFC device to the LLCP layer on the target NFC device.

20. The method of claim 18, wherein the error recovery indication is passed over an NFC controller interface (NCI).

21. The method of claim 15, wherein the time interval of the LTO timer is reset to a start value.

22. The method of claim 15, wherein the time interval of the LTO timer is stalled for an amount of time relevant to a given error recovery attempt.

23. The method of claim 15, wherein it is determined that error recovery is being attempted when a negative acknowledgment message protocol data unit (NACK-PDU) has been received from the initiator inductively coupled communication device.

24. The method of claim 15, wherein it is determined that error recovery is being attempted when an attention request protocol data unit (ATN-PDU) has been received from the initiator inductively coupled communication device.

25. The method of claim 15, wherein it is determined that error recovery is being attempted when a transmission error is detected in an RF frame from the initiator inductively coupled communication device.

26. A target inductively coupled communication device, comprising:
a processor;
memory in electronic communication with the processor; and
instructions stored in the memory, the instructions being executable by the processor to:
send data to an initiator inductively coupled communication device;
start a link timeout (LTO) timer;
determine that a media access control (MAC) layer on the target inductively coupled communication device indicates that error recovery is being attempted; and
extend a time interval of the LTO timer.

27. The target inductively coupled communication device of claim 26, wherein the electronic device is a target near-field communication (NFC) device and the initiator inductively coupled communication device is an initiator NFC device.

28. The target inductively coupled communication device of claim 27, further comprising instructions executable to provide an error recovery indication from the MAC layer to a logical link control protocol (LLCP) layer on the target inductively coupled communication device, wherein the MAC layer is a near-field communication data exchange protocol (NFC-DEP) layer.

29. The target inductively coupled communication device of claim 28, wherein the error recovery indication is passed over an NFC controller interface (NCI).

30. The target inductively coupled communication device of claim 26, wherein it is determined that error recovery is being attempted when at least one of a negative acknowledgment message protocol data unit (NACK-PDU) or an attention request protocol data unit (ATN-PDU) has been received from the initiator inductively coupled communication device.
